(19) United States
(12) Patent Application Publication
(10) Pub. No.: US 2012/0198134 A1
(43) Pub. Date: Aug. 2, 2012

(54) MEMORY CONTROL APPARATUS THAT CONTROLS DATA WRITING INTO STORAGE, CONTROL METHOD AND STORAGE MEDIUM THEREFOR, AND IMAGE FORMING APPARATUS

(75) Inventor: Tsunahito NAKASHITA, Mitaka-shi (JP)

(73) Assignee: CANON KABUSHIKI KAISHA, Tokyo (JP)

(21) Appl. No.: 13/358,572

(22) Filed: Jan. 26, 2012

(30) Foreign Application Priority Data
Jan. 27, 2011 (JP) 2011-015199

(51) Int. Cl. G06F 12/00

(52) U.S. Cl. 711/103; 711/E12.008

(57) ABSTRACT

A memory control apparatus capable of preventing the performance from being lowered at the time of data deletion. The memory control apparatus includes a CPU and a storage controller of a main controller and includes a memory controller of an SSD of the main controller. The memory controller selectively performs first write processing to write data into a flash memory of the SSD or second write processing to write data into the flash memory after unnecessary data recorded in the flash memory is deleted. In a case where a deletion mode to delete unnecessary data is set, the CPU causes the memory controller to perform the second write processing, if the capacity of data to be written exceeds a predetermined data capacity.

### BACKGROUND OF THE INVENTION

1. Field of the Invention

The present invention relates to a memory control apparatus that controls data writing into a storage, a control method and a storage medium therefor, and an image forming apparatus. In particular, the present invention relates to a memory control apparatus that controls data writing into and data deletion from a semiconductor disk (hereinafter, referred to as the SSD) having a flash memory, a control method therefor, a storage medium storing a program for executing the control method, and an image forming apparatus mounted with the memory control apparatus.

2. Description of the Related Art

An image forming apparatus is generally mounted with a hard disk drive (HDD) in which programs and image data are stored.

In recent years, SSDs become larger in capacity and lower in cost and are rapidly widely used for mobile PCs (personal computers). SSDs are capable of being randomly accessed at higher speed than HDDs and advantageous in that they are low in power consumption, high in impact resistance, light weight, and space saving.

In particular, SSDs do not require an initial operation (such as spin up required for system startup of HDDs), which together with high data transfer is extremely advantageous to shorten a startup time. Since SSDs have no disk drive part liable to be broken by impact, they are excellent not only in impact resistance but also in heat resistance. Thus, SSDs have attracted the attention as storage devices of image forming apparatuses.

However, a flash memory which is a storage device mounted on an SSD has an upper limit on the number of writable times. For example, the number of writable times is about 100000 times for SLC (single level cell) and 10000 for MLC (multiple level cell). Since the flash memory fabrication process becomes finer, there is a tendency that the writable number of times of the flash memory decreases.

To cope with the limited number of writable times of the flash memory, a flash memory controller mounted on the SSD evenly distributes a writing destination to various areas of the flash memory in order to prevent concentration of the frequency of writing to the same area, whereby the service life of the flash memory, i.e., the service life of the storage device, can be prolonged. This technique is called ware leveling.

On the other hand, it is highly demanded to ensure security of data such as image data and to protect privacy. As for image forming apparatuses, it is demanded that spooled data and saved data which are recorded in a storage can be completely deleted.

In HDDs, residual magnetism is removed and data to be deleted is completely deleted by overwriting dummy data multiple times into an area in which the data to be deleted is recorded (see, Japanese Laid-open Patent Publications Nos. 2004-153516 and 2006-23854).

In SSDs, unlike HDDs, it is possible to completely delete data to be deleted by performing rewriting once. However, data to be deleted cannot directly be rewritten due to ware leveling by means of normal write processing and special write processing must be made in order to completely delete data to be deleted.

Incidentally, data deletion in a flash memory must be made in units of predetermined block due to its characteristics. The special write processing compatible to complete deletion poses a problem that the performance is remarkably lowered due to overhead at data deletion, if data to be written has a size smaller than the block size of the flash memory.

An operation system running on an image forming apparatus writes, into the flash memory, data such as image data having a size sufficiently larger than the block size of the flash memory, and also frequently writes, into the flash memory, management information for the file system having a size (e.g., not larger than 8 k bites) less than the block size. Thus, a problem is posed that serious performance down occurs, if all these pieces of data are written in a complete deletion mode.

Since the flash memory fabrication process becomes finer, flash memories released in the future will have a large-capacity page size and the block size will be large. Accordingly, as compared to the prior flash memory, there will more frequently occur a situation where data having a size smaller than the block size is written, resulting in performance down.

To increase the speed and capacity of a storage, the storage is sometimes constituted by flash memories which are arranged in parallel with one another. Also in that case, the just-mentioned problem is caused since the block size becomes virtually large due to the parallel arrangement of the flash memories.

To eliminate the above problems, a type of data to be written (such as, for example, image data or management information) must be identified with accuracy and pieces of data to be subjected to the write processing compatible to complete deletion must be narrowed down.

However, there is a problem that a general-purpose operating system such as LINUX used in image forming apparatuses cannot identify the data type at the time of data writing.

In addition, since the write processing in the complete deletion mode is processing that is specialized for SSDs, a special write instruction must be given for the write processing. If such an instruction is given to a storage device (e.g., an HDD) that does not support the special write processing, a problem is posed that data writing cannot be carried out and hang-up is caused.

### SUMMARY OF THE INVENTION

The present invention provides a memory control apparatus capable of preventing the performance from being lowered at the time of data deletion, a control method and a storage medium therefor, and an image forming apparatus.

The present invention also provides a memory control apparatus capable of preventing occurrence of a situation where data cannot be written and hang-up is caused, a control method and a storage medium therefor, and an image forming apparatus.

According to one aspect of this invention, there is provided a memory control apparatus that controls data writing into a storage having at least one flash memory, which comprises a write processing unit configured to selectively perform first write processing to write data into the flash memory or second write processing to write data into the flash memory after unnecessary data recorded in the flash memory is deleted, a write switching unit configured to cause the write processing unit to selectively perform one of the first write processing and the second write processing, and a determination unit configured, in a case where a deletion mode to delete unnecessary data is set, to determine whether or not a capacity of data to be written is equal to or less than a predetermined data capacity, wherein in a case where it is determined by the determination unit that the capacity of data to be written exceeds the predetermined data capacity, the write switching unit causes the write processing unit to perform the second write processing.

With this invention, it is possible to prevent the performance from being lowered at the time of data deletion and to prevent occurrence of a situation where data cannot be written and hang-up is caused.

The memory control apparatus of this invention can further include a logical address management table configured to be capable of being arbitrarily set with logical addresses that are assigned to the storage, and a logical address check unit configured to check a write destination logical address specified when data writing to the storage is requested against each of the logical addresses set in the logical address management table. In a case where the specified write destination logical address coincides with any of the logical addresses set in the logical address management table and the capacity of data to be written exceeds the predetermined data capacity, the write switching unit can cause the write processing unit to perform the second write processing. In a case where the capacity of data to be written is less than the predetermined data capacity or the specified write destination logical address coincides with none of the logical addresses set in the logical address management table, the write switching unit can cause the write processing unit to perform the first write processing.

In that case, logical areas into which data to be completely deleted are written can be determined in advance, and logical addresses of the logical areas can be tabulated. It is therefore possible to determine based on the logical addresses whether data to be written is data to be completely deleted, whereby the performance can further be suppressed from being lowered as compared to a case where the first or second write processing is selectively performed based only on the capacity of data to be written.

Further features of the present invention will become apparent from the following description of an exemplary embodiment with reference to the attached drawings.

### BRIEF DESCRIPTION OF THE DRAWINGS

FIG. 1 is a block diagram showing the construction of a control system of an image forming system that includes a memory control apparatus according to one embodiment of this invention;

FIG. 2 is a block diagram showing an example construction of a main controller of the control system of the image forming system;

FIG. 3 is a view showing an example of an operation unit of an image forming apparatus of the image forming system;

FIG. 4 is a block diagram showing an example internal construction of an SSD of the main controller;

FIG. 5 is a flowchart showing procedures of dynamic switching control performed when data is written into the SSD;

FIG. 6 is a flowchart showing procedures of switching control performed in the SSD when the switching control shown in FIG. 5 is executed;

FIG. 7 is a flowchart showing procedures of a collective deletion process performed on data in one or more unused blocks of the SSD when the control system of the image forming system shown in FIG. 1 is shut down;

FIG. 8 is a flowchart showing procedures of a collective deletion process performed on data in one or more unused blocks of the SSD when the control system of the image forming system is brought to or in an idle state;

FIG. 9 is a flowchart showing procedures of switching control performed in a case where data file information as a further switching condition is added to write processing switching conditions in the switching control shown in FIG. 5;

FIG. 10 is a flowchart showing procedures of switching control performed in a case where as a further switching condition, a logical address of a data write destination is added to the write processing switching conditions in the switching control shown in FIG. 5; and

FIG. 11 is a schematic view showing an example construction of the image forming system.

### DESCRIPTION OF THE EMBODIMENTS

The present invention will now be described in detail below with reference to the drawings showing a preferred embodiment thereof.

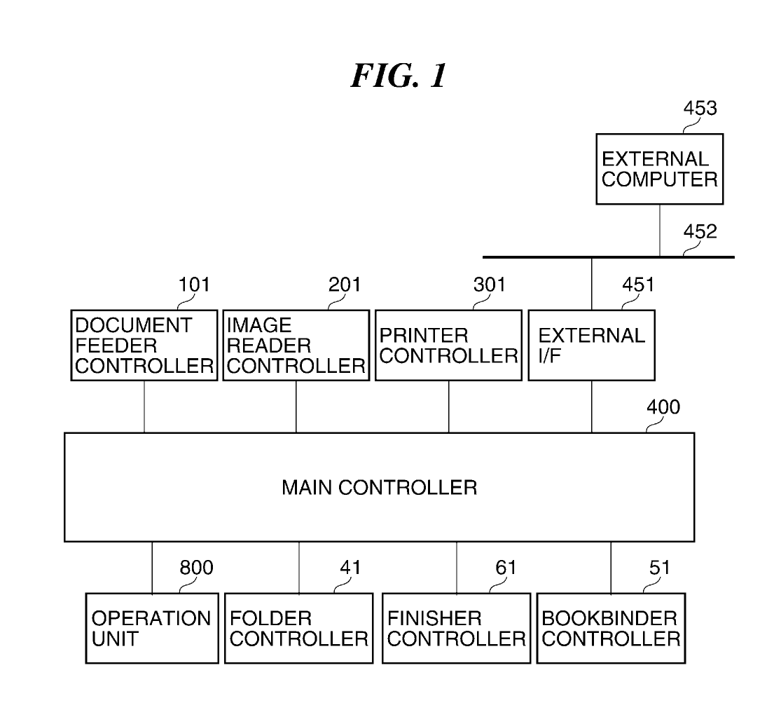

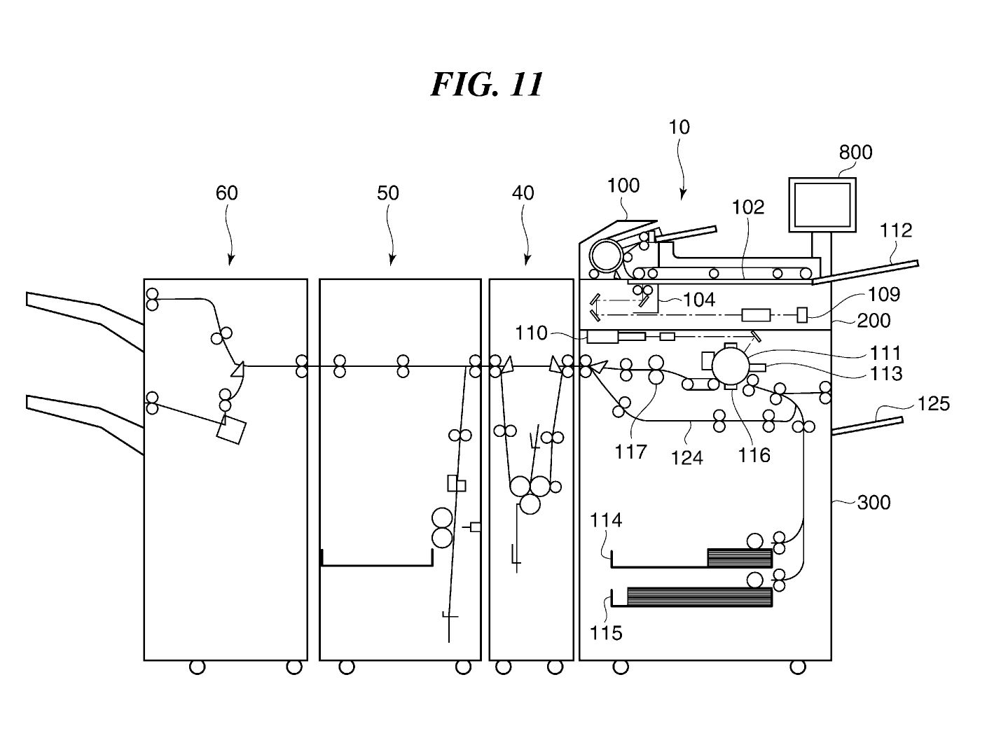

FIG. 1 shows in block diagram the construction of a control system of an image forming system that includes a memory control apparatus according to one embodiment of this invention. FIG. 11 schematically shows an example construction of the image forming system.

The image forming system is conventionally known and briefly described below. As shown in FIG. 11, the image forming system includes an image forming apparatus 10, folding unit 40, bookbinding unit 50, and finisher 60 that operate under the control of the control system, which is shown in FIG. 1 and mounted on the image forming apparatus 10.

The image forming apparatus 10 includes an image reader 200 (mounted with a document feeder 100), a printer 300, and an operation unit 800. Originals placed on an original tray of the document feeder 100 are fed one by one to a platen glass 102, and original images are sequentially read by the image reader 200. More specifically, the image of each original is read by a scanner unit 104 held at a predetermined position, with the original conveyed along the platen glass 102. Alternatively, the original image is read by moving the scanner unit 104 along the platen glass 102, with the original stopped at a reading position on the platen glass 102. In a case that an original is not fed from the document feeder 100 but placed by a user on the platen glass 102, the original image can be read by moving the scanner unit 104 along the platen glass 102.

At the time of image reading, the scanner unit 104 irradiates lamp light to an original. Light reflected from the original enters an image pickup surface of an image sensor 109 through a mirror, etc. and an original image is formed thereon. The image sensor 109 reads and converts the original image into image data, which is output to an exposure controller 110 of the printer 300. After the original image is read, the original is discharged to a discharge tray 112.

The exposure controller 110 modulates laser light according to the image data. The laser light is irradiated through a polygon mirror onto a photosensitive drum 111, whereby an electrostatic latent image is formed thereon. The latent image is visualized by a developing device 113 into a toner image. In synchronism with irradiation of laser light, a sheet is fed from a cassette 114 or 115 and conveyed between the photosensitive drum 111 and a transfer device 116 by which the toner image is transferred onto the photosensitive drum 111. The toner image is then fixed to the sheet by a fixing device 117, and the sheet is discharged from the printer 300.

Sheets discharged from the printer 300 are conveyed to the folding unit 40, the bookbinding unit 50, or the finisher 60 and subjected to post-processing therein, where required.

The image forming apparatus 10 is capable of performing manual-feed printing and double-sided printing. Reference numerals 124, 125 denote a conveyance path for double-sided printing and a sheet feed tray for manual-feed printing, respectively.

Referring to FIG. 1, the control system of the image forming system includes a main controller 400 that controls the image forming apparatus 10. A document feeder controller 101, image reader controller 201, printer controller 301 (print unit), folder controller 41, bookbinder controller 51, finisher controller 61, and operation unit 800 are connected to the main controller 400. The main controller 400 is connected through an external interface (I/F) 451 with an external bus 452 (such as a network or a USB) to which an external computer 453 is connected.

The main controller 400 controls the document feeder controller 101 and the image reader controller 201 in accordance with an instruction given from the operation unit 800 or from the external computer 453. The document feeder controller 101 controls the document feeder 100 to feed an original to the reading position. The image reader controller 201 controls the image reader 200 to read an original image and obtain image data. Under the control of the main controller 400, the printer controller 301 controls the printer 300 to form an image on a sheet according to image data by means of an electrophotographic process or the like.

Under the control of the main controller 400, the folder controller 41, bookbinder controller 51, and finisher controller 61 respectively control the folding unit 40, bookbinding unit 50, and finisher 60 to perform post-processing on sheets such as folding, stapling, or punching.

Furthermore, the main controller 400 receives print data from the external computer 453 through the external I/F 451 and controls the printer controller 301 to execute printing according to the print data. The main controller 400 transmits image data recorded in storage equipment (described later) to the external computer 453 through the external I/F 451.

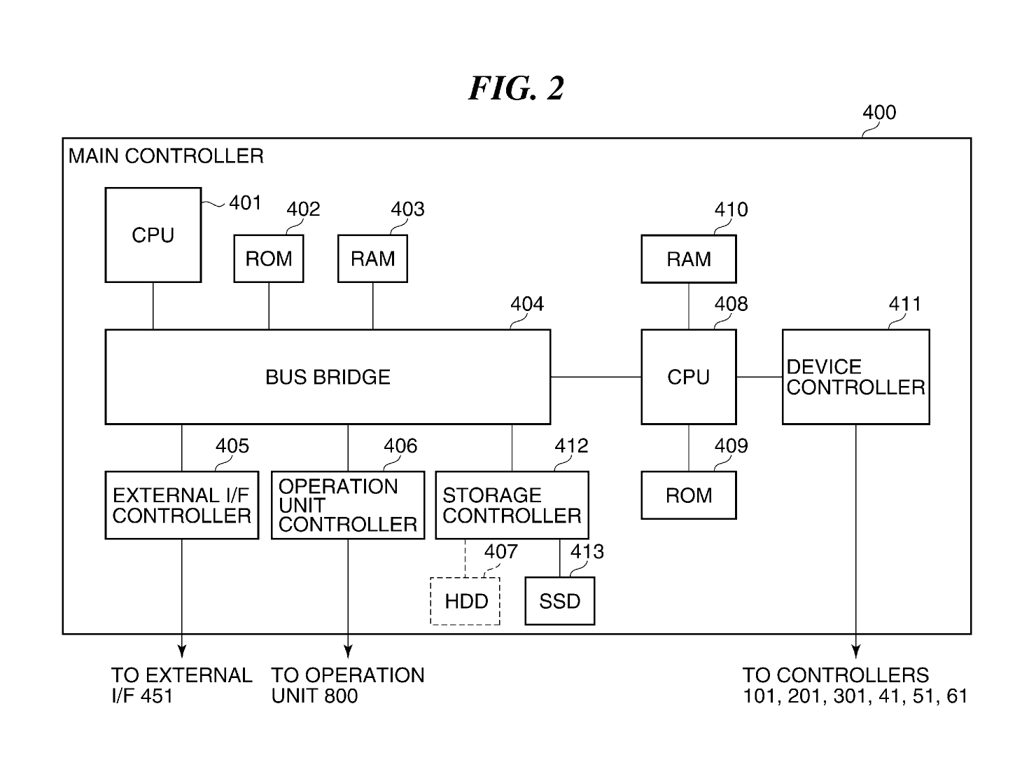

FIG. 2 shows in block diagram an example construction of the main controller 400.

As shown in FIG. 2, the main controller 400 includes CPUs 401 and 408 on each of which an operating system (hereinafter, referred to as the OS) runs.

The CPU 401 is connected with a bus bridge 404 and communicates with the CPU 408 through the bus bridge 404 to which a ROM 402, RAM 403, external I/F controller 405, operation unit controller 406, and storage controller 412 are connected. An initial startup program for the CPU 401 is stored in the ROM 402. Control data for the CPU 401 is temporarily stored in the RAM 403, which is also used as a work area for the CPU 401.

The external I/F controller 405 is connected to and controls the external I/F 451. The operation unit controller 406 is connected to and controls the operation unit 800. The storage controller 412 is connected with a semiconductor storage (hereinafter referred to as the SSD) 413, which is storage equipment. A hard disk drive (hereinafter, referred to as the HDD) 407 which is storage equipment can optionally be connected, as shown by a dotted block, to the storage controller 412. The storage controller 412 controls the SSD 413 and the HDD 407.

The SSD 413 stores, e.g., a main program including the OS that runs on the CPUs 401 and 408. If the option HDD 407 is not connected, image data acquired by the image reader 200 or the external I/F 451 is stored in the SSD 413.

In a case that the option HDD 407 is not connected, image data edited according to operation of the operation unit 800 is stored in the SSD 413, and application programs and all data including user preference data are stored in the SSD 413. In the illustrated example, the SSD 413 is used as a flash disk.

On the other hand, if the option HDD 407 is connected, image data acquired by the image reader 200 or the external I/F 451 or edited according to operation of the operation unit 800 is stored in the HDD 407. The HDD 407 is also used as a storage destination for application programs and user preference data. In that case, the CPUs 401 and 408 are capable of accessing the HDD 407 through the storage controller 412.

The CPU 408 is connected with a ROM 409, RAM 410, and device controller 411 as well as with the bus bridge 404. An initial startup program for the CPU 408 is stored in the ROM 409. Control data for the CPU 408 is temporarily stored in the RAM 410, which is also used as a work area for the CPU 408.

The device controller 411 controls the document feeder controller 101, image reader controller 201, printer controller 301, folder controller 41, bookbinder controller 51, and finisher controller 61.

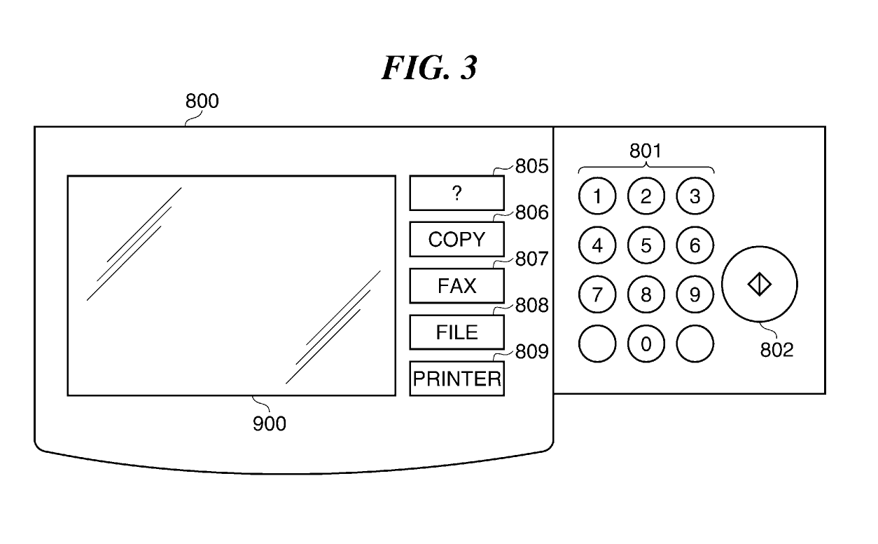

FIG. 3 shows an example of the operation unit 800 of the image forming apparatus 10.

The operation unit 800 has an LCD display unit 900 having an LCD (liquid crystal display) and a touch-panel sheet affixed thereon. On the LCD display unit 900, there is displayed an operation screen. When any of keys displayed on the operation screen is pressed, position information of the pressed key is conveyed to the main controller 400, and the main controller 400 executes control according to the position information.

The operation unit 800 has ten keys 801 for use by a user to input, e.g., the number of copies to be made. Further, the operation unit 800 has a start key 802, guide key 805, copy mode key 806, FAX key 807, file key 808, and printer key 809.

When the start key 802 is pressed by the user after desired conditions are set, a copy operation or an original reading operation is started, for example. When the guide key 805 is pressed, an explanation for functions of respective keys is displayed on the LCD display unit 900. The copy mode key 806 is used to execute copying. The FAX key 807 is used to make FAX settings. The file key 808 is used to output file data. The printer key 809 is used to make settings, e.g., for print-out of image data that is transmitted from an external apparatus such as the external computer 453.

In the following, a description will be given of dynamic switching control performed when data is written into the SSD 413 in a case where the image forming apparatus 10 is set in a data complete deletion mode to completely delete unnecessary data.

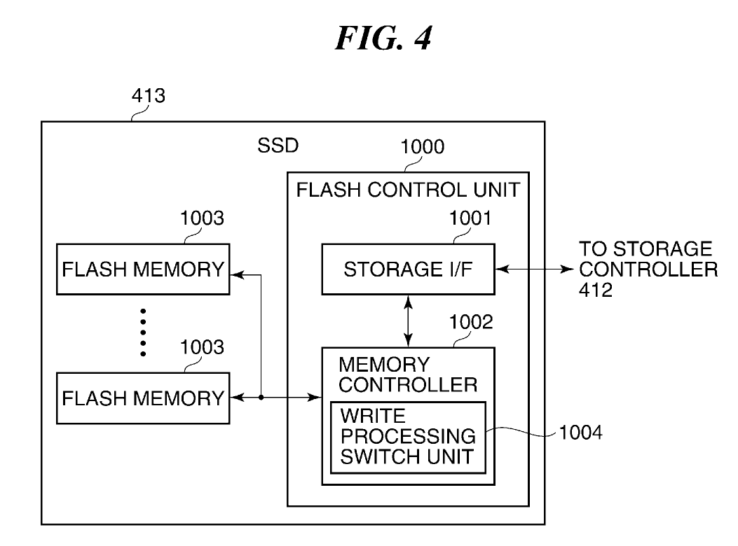

FIG. 4 shows in block diagram an example internal construction of the SSD 413.

As shown in FIG. 4, the SSD 413 has a flash control unit 1000 and flash memories 1003. The flash control unit 1000 has a storage I/F 1001 and a memory controller 1002. The storage I/F 1001 is connected to the storage controller 412. In other words, the storage I/F 1001 is a module that communicates with the storage controller 412. In the illustrated example, a serial ATA (serial AT attachment) interface, i.e., SATA interface, is used as the storage I/F 1001.

In accordance with an instruction received by the storage I/F 1001, the memory controller 1002 performs data reading/writing to one of the flash memories 1003 (hereinafter, referred to as the flash memory 1003). The memory controller 1002 is provided with a write processing switch unit 1004.

The memory controller 1002 causes the write processing switch unit 1004 to selectively perform first or second write processing. In the first write processing (normal write processing), data is written into the flash memory 1003. In the second write processing, unnecessary data recorded in the flash memory 1003 is deleted and then data is written into the flash memory 1003.

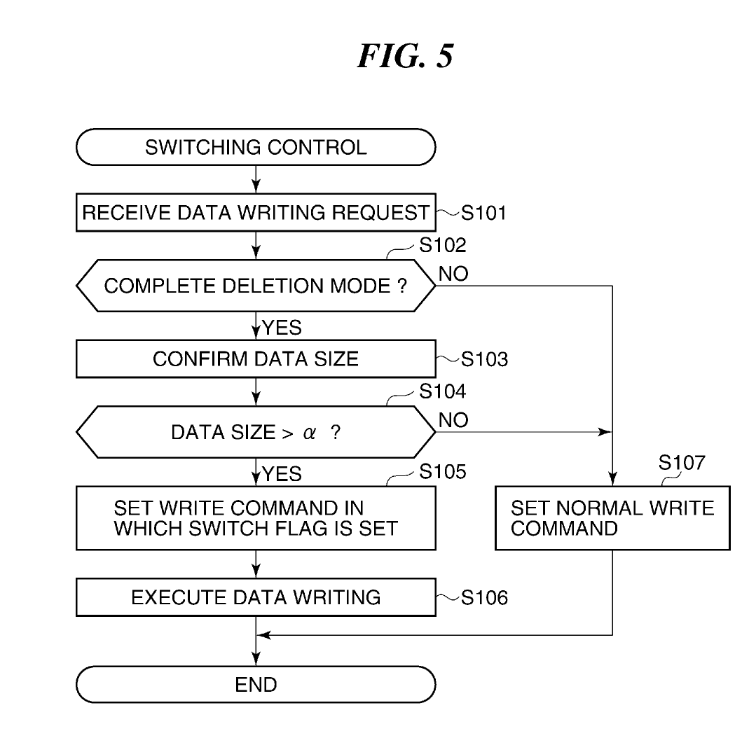

FIG. 5 shows, in flowchart, procedures of dynamic switching control performed when data is written into the SSD 413. The switching control is executed by the CPU 401 of the main controller 400.

When data writing to the SSD 413 is requested by the OS running on the CPU 401, the CPU 401 receives the data writing request (step S101) and confirms whether the image forming apparatus 10 is set in a complete deletion mode to completely delete unnecessary data (step S102).

If the image forming apparatus 10 is set in the complete deletion mode (i.e., if YES to step S102), the CPU 401 confirms the size or capacity of data to be written (step S103).

If the size or capacity of data to be written is larger than a predetermined data size or capacity α (i.e., if YES to step S104), the CPU 401 sets a data write instruction (write command) having predetermined flag data used to switch write processing (step S105), the predetermined flag data being set in a switch flag area (e.g., an area ignored by devices other than a particular device compatible to a switch flag) of the data write instruction. Hereinafter, the data write instruction having the predetermined flag data set in the switch flag area (i.e., the data write instruction set with the switch flag) will be referred to as the switching write instruction.

As the switch flag area, a features register is used in the case of, e.g., a SATA or ATA standard storage interface.

Next, the CPU 401 transmits the switching write instruction and data to be written to the SSD 413 through the storage controller 412 to execute data writing (step S106), whereupon the switching control is completed.

On the other hand, if the image forming apparatus 10 is not set in the complete deletion mode (i.e., if NO to step S102) or if the size of data to be written is equal to or less than the predetermined data size α (i.e., if NO to step S104), the CPU 401 sets a normal data write instruction, which will be referred to as the normal write instruction (step S107). The normal write instruction is a data write instruction set with no switch flag. Next, the flow proceeds to step S106 where the CPU 401 executes data writing.

In the following, the switching write instruction and the normal write instruction will collectively be referred to as the data write instruction.

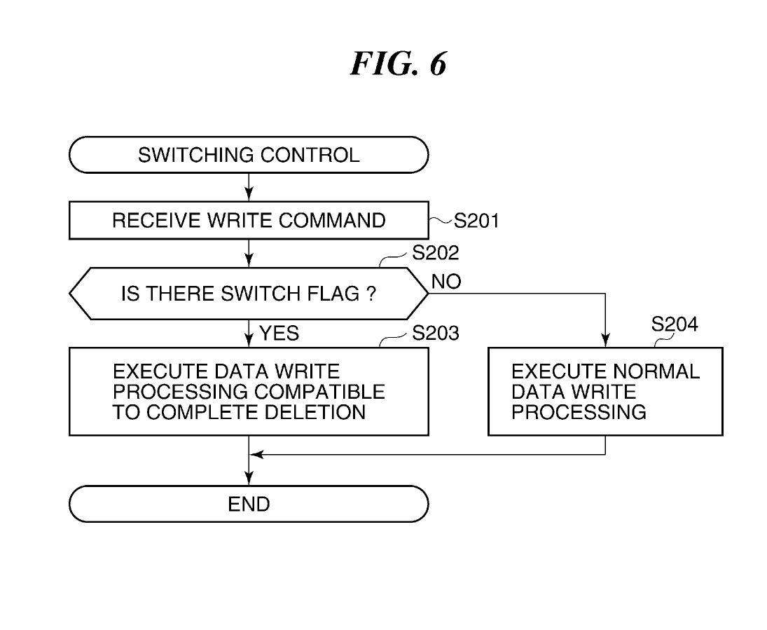

FIG. 6 shows, in flowchart, procedures of switching control performed in the SSD 413 when the switching control shown in FIG. 5 is executed.

When the data write instruction is transmitted from the storage controller 412 to the SSD 413 as previously described in step S106 of FIG. 5, the SSD 413 receives the data write instruction at the storage I/F 1001 (step S201).

The memory controller 1002 of the SSD 413 confirms whether there is a switch flag (complete deletion flag) in the data write instruction (step S202). In other words, the memory controller 1002 confirms whether the received data write instruction is a switching write instruction or a normal write instruction.

If there is the switch flag in the data write instruction (i.e., if YES to step S202), the memory controller 1002 executes write processing compatible to complete deletion to write data into the flash memory 1003 (step S203), whereupon the switching control is completed. On the other hand, if there is no switch flag in the data write instruction (i.e., if NO to step S202), the memory controller 1002 executes normal write processing to write data into the flash memory 1003 (step S204), whereupon the switching control is completed.

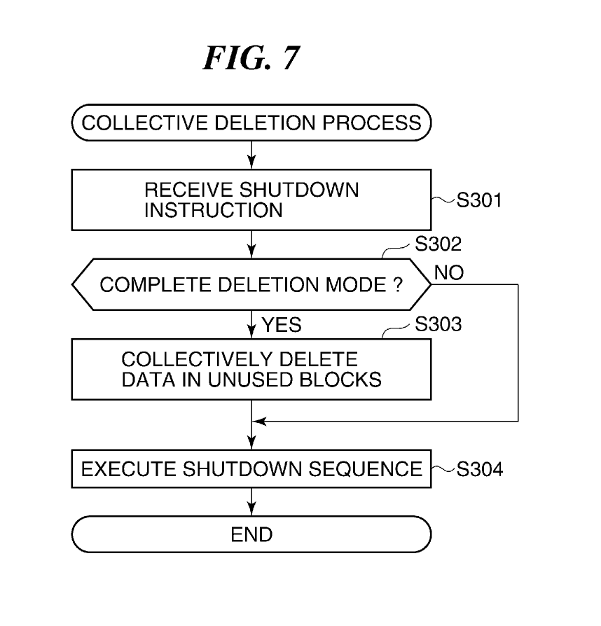

FIG. 7 shows, in flowchart, procedures of a collective deletion process performed on data in one or more unused blocks of the SSD 413 when the control system of the image forming system shown in FIG. 1 is shut down.

When a shutdown instruction is issued from the OS running on the CPU 401, the CPU 401 receives the shutdown instruction (step S301), and confirms whether the image forming apparatus 10 is set in a complete deletion mode to completely delete unnecessary data (step S302). If the image forming apparatus 10 is not set in the complete deletion mode (i.e., if NO to step S302), the flow proceeds to step S304.

If the image forming apparatus 10 is set in the complete deletion mode (i.e., if YES to step S302), the CPU 401 executes through the storage controller 412 a collective deletion instruction for one or more unused blocks (i.e., blocks not used before the shutdown) of the flash memories 1003 of the SSD 413 (step S303), whereby one or more pieces of residual data equal to or less than 8 K bites in the one or more unused blocks are collectively deleted.

Subsequently, the CPU 401 executes a shutdown sequence (step S304), whereupon the collective deletion process is completed.

It should be noted that the collective deletion process of FIG. 7 can be performed at startup of the image forming apparatus 10.

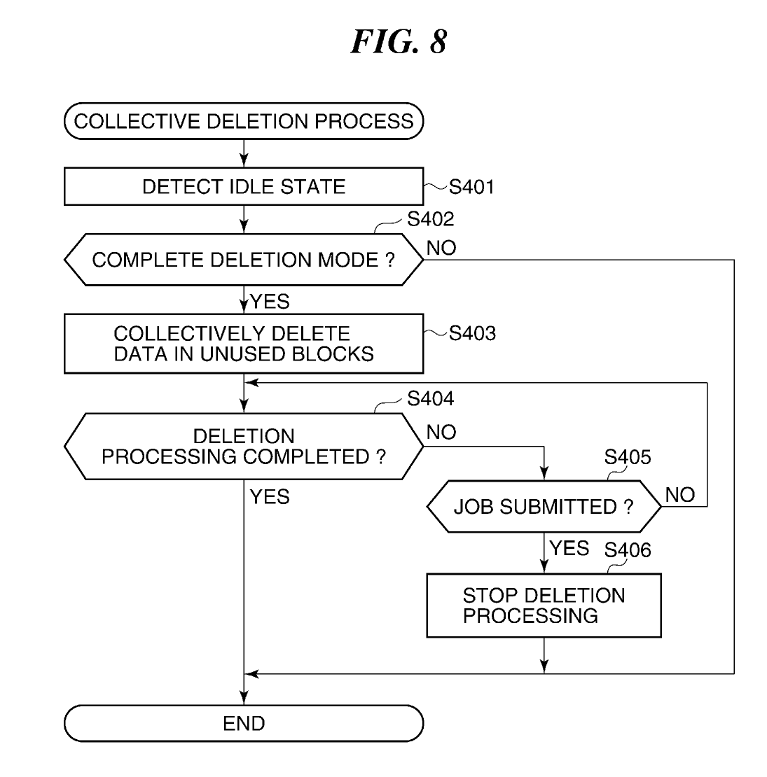

FIG. 8 shows, in flowchart, procedures of a collective deletion process performed on data in one or more unused blocks of the SSD 413 when the control system of the image forming system shown in FIG. 1 is brought to or in an idle state.

When determining that the image forming apparatus 10 is brought to or in an idle state (step S401), the CPU 401 confirms whether the image forming apparatus 10 is set in the complete deletion mode (step S402). If the image forming apparatus 10 is not set in the complete deletion mode (i.e., if NO to step S402), the collective deletion process is completed.

On the other hand, if the image forming apparatus 10 is set in the complete deletion mode (i.e., if YES to step S402), the CPU 401 executes through the storage controller 412 a collective deletion instruction for one or more unused blocks (i.e., blocks not used before the image forming apparatus 10 is brought to an idle state) of the flash memories 1003 of the SSD 413 (step S403).

Next, the CPU 401 confirms the status of progress of deletion processing and determines whether the deletion processing is completed (step S404). If the deletion processing is completed (i.e., if YES to step S404), the CPU 401 completes the collective deletion process.

On the other hand, if the deletion processing is not completed (i.e., if NO to step S404), the CPU 401 confirms whether a job such as a print job is newly submitted (step S405). If no job is submitted (i.e., if NO to step S405), the flow returns to step S404 where the CPU 401 confirms whether the deletion processing is completed.

If a job is submitted (i.e., if YES to step S405), the CPU 401 stops the deletion processing (step S406), whereupon the collective deletion process is completed.

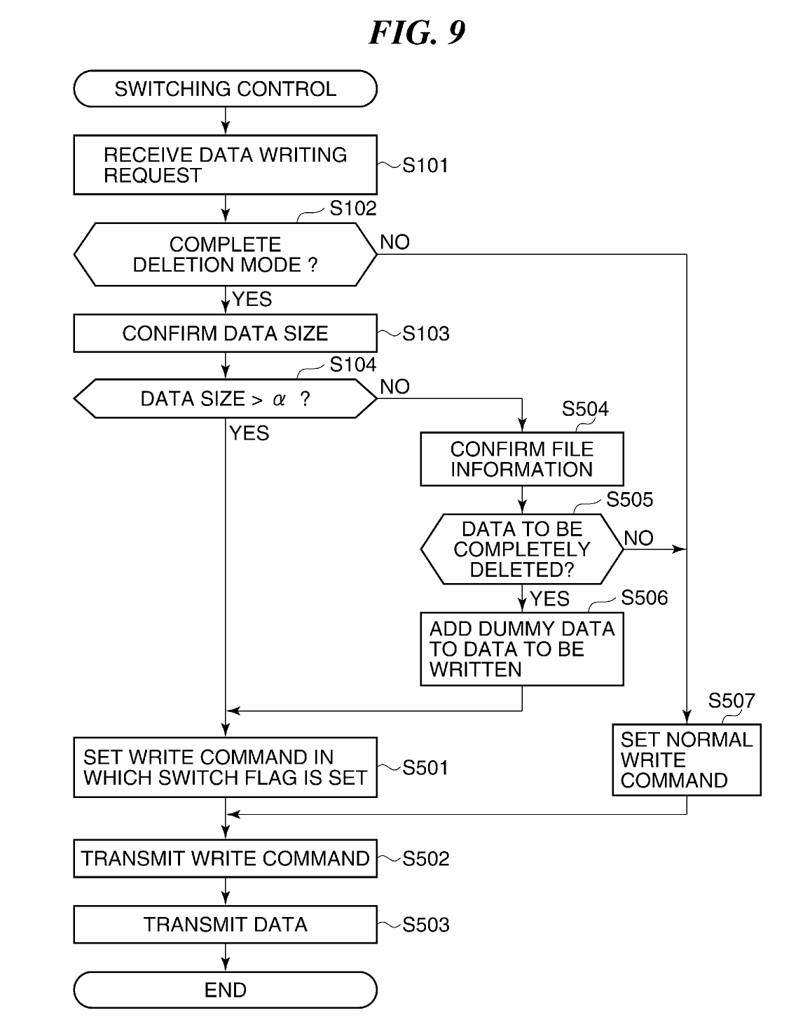

FIG. 9 shows, in flowchart, procedures of switching control performed in a case where data file information as a further switching condition is added to the write processing switching conditions (i.e., operation mode of image forming apparatus and data size) in the switching control shown in FIG. 5.

In steps S101 to S104, S501 to S503, and S507 in FIG. 9, the same processing as that in steps S101 to S107 in FIG. 5 is performed. In the following, a description of steps S101 to S103 of FIG. 9 is omitted.

If the size of data to be written is larger than the predetermined data size α (i.e., if YES to step S104), the CPU 401 sets a data write instruction set with a switch flag, i.e., a switching write instruction (step S501), and transmits to the SSD 413 through the storage controller 412 the switching write instruction and the data to be written (steps S502 and S503).

If the size of data to be written is equal to or less than the predetermined data size α (i.e., if NO to step S104), the CPU 401 confirms file information in the data to be written (step S504), and determines based on the file information whether the data to be written is data to be completely deleted (step S505).

If the data to be written is data to be completely deleted (i.e., if YES to step S505), the CPU 401 adds dummy data to the data to be written so that the resultant data has a size equal to or larger than the block size of the flash memory 1003 (step S506), whereupon the flow proceeds to step S501.

If the image forming apparatus 10 is not set in the complete deletion mode (i.e., if NO to step S102) or if the data to be written is not data to be completely deleted (i.e., if NO to step S505), the CPU 401 sets the normal write instruction (step S507), whereupon the flow proceeds to step S502.

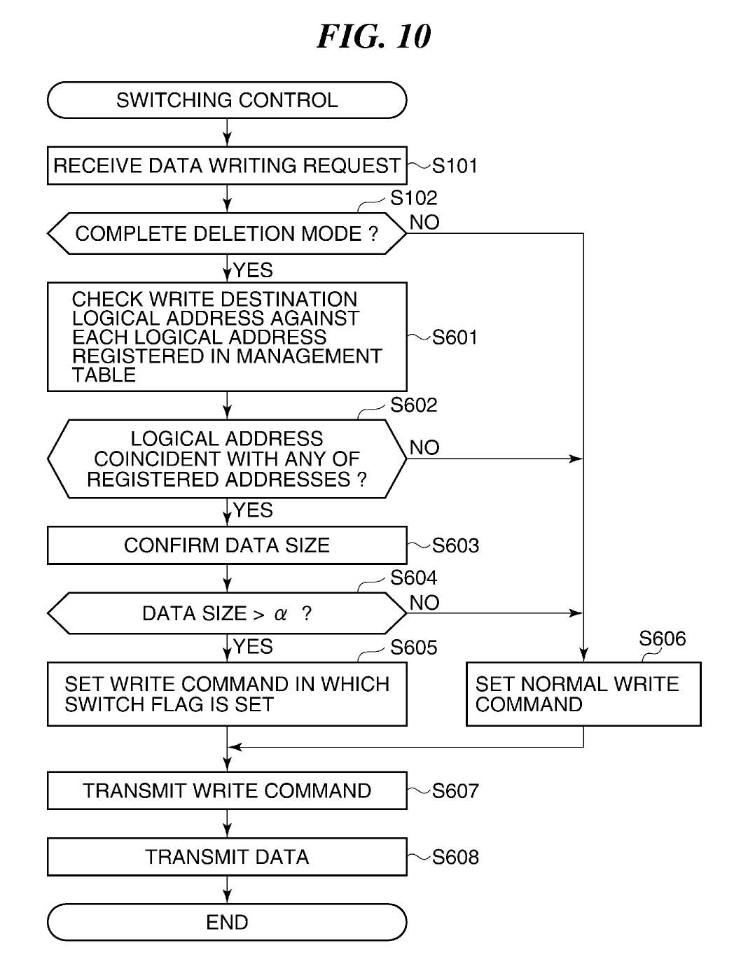

FIG. 10 shows, in flowchart, procedures of switching control performed in a case where as a further switching condition, a logical address assigned to the semiconductor storage is added to the write processing switching conditions (i.e., operation mode of image forming apparatus and data size) in the switching control shown in FIG. 5.

In steps S101 and S102 of FIG. 10, the same processing as that in steps S101 and S102 of FIG. 5 is performed. If the image forming apparatus 10 is set in the complete deletion mode (i.e., if YES to step S102), the CPU 401 checks a logical address of a write destination of data to be written against each of logical addresses registered in a logical address management table (step S601).

The logical address management table is for managing, as table data, logical addresses that represent predetermined logical areas into which pieces of data to be completely deleted are written. The table data is stored in, e.g., the RAM 403. It should be noted that a storage destination of the table data is not limited to the RAM 403, but may be any rewritable storage medium. The SSD 413 may be used so long as the performance is not affected.

If the logical address of the write destination of the data to be written coincides with any of the logical addresses registered in the logical address management table (i.e., if YES to step S602), the CPU 401 confirms the size of the data to be written (step S603).

Next, the CPU 401 determines whether the size of the data to be written is larger than the predetermined data size α (step S604). In the logical address management table, a threshold value of the size of data to be written (i.e., write processing switching condition) is set for each logical address. In step S604, the threshold value set for the logical address corresponding to the logical address of the write destination of the data to be written is used as the predetermined data size α.

If the size of the data to be written is larger than the predetermined data size α (i.e., if YES to step S604), the CPU 401 sets the switching write instruction, i.e., the data write instruction set with the switch flag (step S605), and transmits to the SSD 413 through the storage controller 412 the switching write instruction (write command) and the data to be written (steps S607 and S608).

If the image forming apparatus 10 is not set in the complete deletion mode (i.e., if NO to step S102) or if the logical address of the write destination of the data to be written coincides with none of the logical addresses registered in the logical address management table (i.e., if NO to step S602) or if the size of the data to be written is not larger than the predetermined data size α (i.e., if NO to step S604), the CPU 401 sets a normal write instruction (step S606), whereupon the flow proceeds to step S607.

In the embodiment, since the write processing is dynamically switched according to the size or capacity of data to be written as described above, it is possible to completely delete data to be deleted, without lowering the performance in a semiconductor storage having a flash memory.

Since the switch flag is added to the predetermined area (e.g., area ignored by devices other than a particular device compatible to the switch flag) of the data write instruction issued to the semiconductor storage, it is possible to switch the data write processing for the semiconductor storage according to the switch flag. As a result, even if the writing instruction is issued to a device other than the particular device, the device other than the particular device is able to execute the normal write processing, whereby an erroneous operation can be prevented.

Since one or more pieces of residual data in one or more unused blocks are collectively deleted at startup and shutdown of the image forming apparatus or when the image forming apparatus is brought to or in an idle state, it is possible to delete all the residual data equal to or less than a predetermined data capacity (e.g., 8 K bites), without affecting the performance.

Even if data to be written has a capacity equal to or less than the predetermined data capacity, in a case where it is determined based on file information that data to be written is data to be completely deleted, write processing compatible to complete deletion (second write processing) can be performed on the data to be written after dummy data is added to the data to be written such that the resultant data has such a data capacity that does not affect the performance.

In the embodiment, logical areas into which data to be completely deleted should be written are determined in advance, and logical addresses of the logical areas are tabulated and managed. At the time of data writing, a logical address of a storage destination of the data is checked against each of logical addresses registered in the management table, and data unnecessary to be completely deleted is excluded according to a result of the address check. Subsequently, the write processing is dynamically switched according to the capacity of data to be written. It is therefore possible to further suppress the performance from decreasing due to data complete deletion.

The narrowing down of pieces of data to be completely deleted according to the logical address is also applicable to a general-purpose OS such as LINUX.

Since the threshold value of the capacity of data to be written (i.e. the predetermined data capacity α) according to which the first or second write processing is selectively performed is set in the logical address management table on a per logical address basis, a performance adjustment can be carried out with flexibility.

As apparent from the foregoing description, the CPU 401, storage controller 412, and flash control unit 1000 constitute a memory control apparatus (It should be noted that the memory control apparatus and the below-described units are defined in the appended claims). The flash control unit 1000 functions as a write processing unit, the CPU 401 functions as a write switching unit and a determination unit, the CPU 401 and the flash control unit 1000 function as a deletion unit, and the CPU 401 functions as a confirmation unit and a dummy addition unit.

### Other Embodiments

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2011-015199, filed Jan. 27, 2011, which is hereby incorporated by reference herein in its entirety.

1. A memory control apparatus that controls data writing into a storage having at least one flash memory, comprising:
a write processing unit configured to selectively perform first write processing to write data into the flash memory or second write processing to write data into the flash memory after unnecessary data recorded in the flash memory is deleted;
a write switching unit configured to cause said write processing unit to selectively perform one of the first write processing and the second write processing; and
a determination unit configured, in a case where a deletion mode to delete unnecessary data is set, to determine whether or not a capacity of data to be written is equal to or less than a predetermined data capacity,
wherein in a case where it is determined by said determination unit that the capacity of data to be written exceeds the predetermined data capacity, said write switching unit causes said write processing unit to perform the second write processing.

2. The memory control apparatus according to claim 1, wherein in a case where it is determined by said determination unit that the capacity of data to be written exceeds the predetermined data capacity, said write switching unit sets a switch flag in a write instruction and transmits the write instruction set with the switch flag to said write processing unit, and said write processing unit performs the second write processing in accordance with the write instruction set with the switch flag.

3. The memory control apparatus according to claim 2, wherein the switch flag is set in a features register of SATA or ATA standard, the features register being a redetermined area of the write instruction.

4. The memory control apparatus according to claim 1, further including:
a deletion unit configured to delete residual data having a capacity equal to or less than the predetermined data capacity,
wherein said write processing unit writes data in units of predetermined block into the flash memory, and in a case where there is at least one piece of residual data in at least one block unused before startup or shutdown of the memory control apparatus, said deletion unit collectively deletes the residual data at startup or shutdown of the memory control apparatus.

5. The memory control apparatus according to claim 1, further including:
a deletion unit configured to delete residual data having a capacity equal to or less than the predetermined data capacity,
wherein said write processing unit writes data in units of predetermined block into the flash memory, and in a case where there is at least one piece of residual data in at least one block unused before the memory control apparatus is brought to an idle state, said deletion unit collectively deletes the residual data when the memory control apparatus is brought to or in the idle state.

6. The memory control apparatus according to claim 1, further including:
a confirmation unit configured, in a case where it is determined by said determination unit that the capacity of data to be written is equal to or less than the predetermined data capacity, to confirm whether the data to be written is data to be deleted by referring to file information of the data to be written; and
a dummy addition unit configured, in a case where it is confirmed by said confirmation unit that the data to be written is the data to be deleted, to add dummy data to the data to be written such that the data to be written has a capacity that is equal to or larger than the predetermined data capacity.

7. The memory control apparatus according to claim 1, further including:
a logical address management table configured to be capable of being arbitrarily set with logical addresses that are assigned to the storage; and
a logical address check unit configured to check a write destination logical address specified when data writing to the storage is requested against each of the logical addresses set in said logical address management table,
wherein in a case where the specified write destination logical address coincides with any of the logical addresses set in said logical address management table and the capacity of data to be written exceeds the predetermined data capacity, said write switching unit causes said write processing unit to perform the second write processing, and in a case where the capacity of data to be written is less than the predetermined data capacity or the specified write destination logical address coincides with none of the logical addresses set in said logical address management table, said write switching unit causes said write processing unit to perform the first write processing.

8. The memory control apparatus according to claim 7, wherein the predetermined data capacity is set for each of the logical addresses in said logical address management table.

9. A control method for controlling a memory control apparatus that controls data writing into a storage having at least one flash memory, comprising:
a first write processing step of writing data into the flash memory;
a second write processing step of writing data into the flash memory after deleting unnecessary data recorded in the flash memory;
a switching step of selecting said first or second write processing step; and
a determination step, in a case where a deletion mode to delete unnecessary data is set, of determining whether or not a capacity of data to be written is equal to or less than a predetermined data capacity,
wherein in a case where it is determined in said determination step that the capacity of data to be written exceeds the predetermined data capacity, said second write processing step is selected in said switching step.

10. The control method according to claim 9, further including:
a logical address check step of checking a write destination logical address specified when data writing to the storage is requested against each of logical addresses set in a logical address management table of the memory control apparatus, the logical address management table being capable of being arbitrarily set with logical addresses that are assigned to the storage,
wherein in a case where the specified write destination logical address coincides with any of the logical addresses set in the logical address management table and the capacity of data to be written exceeds the predetermined data capacity, said second write processing step is selected in said switching step, and
in a case where the capacity of data to be written is less than the predetermined data capacity or the specified write destination logical address coincides with none of the logical addresses set in said logical address management table, said first write processing step is selected in said switching step.

11. A non-transitory computer-readable storage medium storing a program for causing a computer to execute a control method for a memory control apparatus that controls data writing into a storage having at least one flash memory, the control method comprising:
a first write processing step of writing data into the flash memory;
a second write processing step of writing data into the flash memory after deleting unnecessary data recorded in the flash memory;
a switching step of selecting said first or second write processing step; and
a determination step, in a case where a deletion mode to delete unnecessary data is set, of determining whether or not a capacity of data to be written is equal to or less than a predetermined data capacity,
wherein in a case where it is determined in said determination step that the capacity of data to be written exceeds the predetermined data capacity, said second write processing step is selected in said switching step.

12. The storage medium according to claim 11, wherein the control method further includes a logical address check step of checking a write destination logical address specified when data writing to the storage is requested against each of logical addresses set in a logical address management table of the memory control apparatus, the logical address management table being capable of being arbitrarily set with logical addresses that are assigned to the storage,
in a case where the specified write destination logical address coincides with any of the logical addresses set in the logical address management table and the capacity of data to be written exceeds the predetermined data capacity, said second write processing step is selected in said switching step, and
in a case where the capacity of data to be written is less than the predetermined data capacity or the specified write destination logical address coincides with none of the logical addresses set in said logical address management table, said first write processing step is selected in said switching step.

13. An image forming apparatus comprising:
a memory control apparatus that controls data writing into a storage having at least one flash memory, the memory control apparatus including a write processing unit configured to selectively perform first write processing to write data into the flash memory or second write processing to write data into the flash memory after unnecessary data recorded in the flash memory is deleted, a write switching unit configured to cause said write processing unit to selectively perform one of the first write processing and the second write processing, and a determination unit configured, in a case where a deletion mode to delete unnecessary data is set, to determine whether or not a capacity of data to be written is equal to or less than a predetermined data capacity; and
a print unit configured to perform printing of data written into the storage of the memory control apparatus,
wherein in a case where it is determined by said determination unit that the capacity of data to be written exceeds the predetermined data capacity, said write switching unit causes said write processing unit to perform the second write processing.
